(19) United States
(12) Patent Application Publication
(10) Pub. No.: US 2018/0116272 A1
(43) Pub. Date: May 3, 2018

(54) METHODS AND SYSTEMS FOR 3D PRINTING FOOD ITEMS

(71) Applicant: INTERNATIONAL BUSINESS MACHINES CORPORATION, Armonk, NY (US)

(72) Inventors: Christopher J. HARDEE, Raleigh, NC (US); Steven R. JOROFF, Tokyo (JP); Pamela A. NESBITT, Ridgefield, CT (US); Scott E. SCHNEIDER, Rolesville, NC (US)

(73) Assignee: INTERNATIONAL BUSINESS MACHINES CORPORATION, Armonk, NY (US)

(21) Appl. No.: 15/340,099

(22) Filed: Nov. 1, 2016

(51) Int. Cl. A23P 20/20

(52) U.S. Cl. CPC A23P 20/20; A23P 2020/253

(57) ABSTRACT

Embodiments for 3D printing a food item by a processor are described. A request to 3D print a food item is received. Information associated with a consumer of the food item is received. The requested food item is 3D printed based on the information associated with the consumer of the food item.

### BACKGROUND OF THE INVENTION

### Field of the Invention

The present invention relates in general to computing systems, and more particularly, to various embodiments for 3D printing food items.

### Description of the Related Art

3D printing is a process of making solid, three dimensional objects from a digital file. 3D printing processes typically create the object using an additive process in which successive layers of material are laid down or deposited until an object with the desired size and shape is formed. Each of these layers may be considered to be a very thin horizontal cross-sectional “slice” of the end product.

3D printing technology has recently been applied to the creation of food (or food items). As this particular area of 3D printing continues to expand, there is a need for 3D printing systems that allow users (e.g., consumers of the food items) to customize their selections based on their personal preferences, dietary restrictions, etc.

### SUMMARY OF THE INVENTION

Various embodiments for 3D printing a food item by a processor are described. In one embodiment, by way of example only, a method for 3D printing a food item, again by a processor, is provided. A request to 3D print a food item is received. Information associated with a consumer of the food item is received. The requested food item is 3D printed based on the information associated with the consumer of the food item.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a block diagram depicting an exemplary computing node according to an embodiment of the present invention;

FIG. 2 is an additional block diagram depicting an exemplary cloud computing environment according to an embodiment of the present invention;

FIG. 3 is an additional block diagram depicting abstraction model layers according to an embodiment of the present invention;

FIG. 4 is a side view of a 3D food printing device in accordance with aspects of the present invention;

FIG. 5 is a flowchart diagram depicting an exemplary method for 3D printing a food item in which various aspects of the present invention may be implemented; and

FIG. 6 is a flowchart diagram depicting an exemplary method for 3D printing a food item, again in which various aspects of the present invention may be implemented.

### DETAILED DESCRIPTION OF THE DRAWINGS

As previously indicated, as the use of 3D printing to create food (or food items or culinary items) becomes more common, there is a need for 3D printing systems that allow users (e.g., consumers of the food items) to customize their selections based on their personal preferences, dietary restrictions, etc.

For example, consider a scenario in which a user (or consumer of the food item) desires to have a particular food item, such as a pizza, 3D printed. Although the particular 3D printing system (or 3D printer) may already have a recipe for a pizza installed, that particular recipe may not be suitable for the consumer because of various dietary restrictions, such as caloric intake and allergies, and/or personal preference (e.g., with respect to toppings for the pizza). In such an instance, the 3D printing system may not be equipped to create a suitable pizza for that consumer, at least without the consumer manually specifying the exact ingredients (and/or toppings) that will be used to make the pizza. This may be a particular concern with food allergies and conditions such as celiac (or coeliac) disease.

In view of the foregoing, a need exists for 3D food printing methods and systems in which the consumers' preferences and/or dietary restrictions are taken into account during the 3D printing process used to create the food items.

To address these needs, the methods and systems of the present invention use, for example, information associated with the consumer (or consumer information) to, for example, modify an existing recipe for a 3D printed food item or create (or load) a new recipe for a 3D printed food item. In some embodiments, a request (or command) to 3D print a food item is received (e.g., by a control system associated with a 3D food printer). Information associated with the consumer is retrieved (or received) by the system. The food item is 3D printed based on the information associated with the consumer.

In some embodiments, the information associated with the consumer is used to modify an existing recipe for the food item (e.g., a recipe for the food item stored in a memory associated with the 3D food printer) so that the printed food item will comply with the dietary restrictions, allergies, preferences, etc. of the consumer. For example, if the consumer information indicates that the consumer has celiac disease and/or is allergic to particular ingredients in the existing recipe, the recipe may be modified such that the ingredients in the recipe that include gluten are replaced with gluten-free ingredients and/or the ingredients to which the consumer is allergic are omitted and/or replaced with other ingredients. As another example, the consumer information may indicate that the consumer has set a caloric intake limit for each meal. In such an instance, if appropriate, the existing may be modified to, for example, reduce the portion size of the food item and/or replace some of the ingredients with lower calorie ingredients to reduce the calorie count of the food item.

In some embodiments, the consumer information includes a recipe (i.e., a consumer recipe) for the requested food item. That is, the recipe the consumer wishes to use to make the food item may not already be stored in the 3D printing system. Rather, the recipe may be retrieved by (or downloaded onto) the 3D printing system from, for example, a user (or consumer) profile.

In some embodiments, after an appropriate recipe has been determined (e.g., changes have been made to an existing recipe based on the consumer information), the consumer is provided with an indication (e.g., a message) of the changes to the recipe and/or the recipe that will be used before the 3D printing process begins.

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

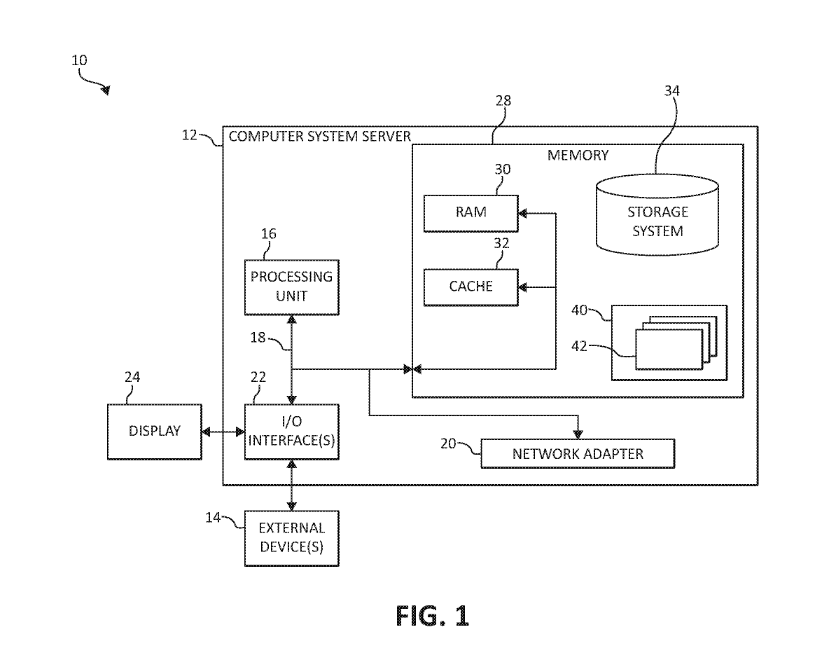

Referring now to FIG. 1, a schematic of an example of a cloud computing node is shown. Cloud computing node 10 is only one example of a suitable cloud computing node and is not intended to suggest any limitation as to the scope of use or functionality of embodiments of the invention described herein. Regardless, cloud computing node 10 is capable of being implemented and/or performing (or causing or enabling) any of the functionality set forth hereinabove.

In cloud computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, computer system/server 12 in cloud computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, system memory 28 may include at least one program product having a set (e.g., at least one) of program modules that are configured to carry out the functions of embodiments of the invention.

Program/utility 40, having a set (at least one) of program modules 42, may be stored in system memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples include, but are not limited to: microcode, device drivers, redundant processing units, external disk drive arrays, RAID systems, tape drives, and data archival storage systems, etc.

In the context of the present invention, and as one of skill in the art will appreciate, various components depicted in FIG. 1 may be located in, for example, personal computer systems, hand-held or laptop devices, and network PCs. However, in some embodiments, some of the components depicted in FIG. 1 may be located in a 3D printing device, such as a 3D food printer. For example, some of the processing and data storage capabilities associated with mechanisms of the illustrated embodiments may take place locally via local processing components, while the same components are connected via a network to remotely located, distributed computing data processing and storage components to accomplish various purposes of the present invention. Again, as will be appreciated by one of ordinary skill in the art, the present illustration is intended to convey only a subset of what may be an entire connected network of distributed computing components that accomplish various inventive aspects collectively.

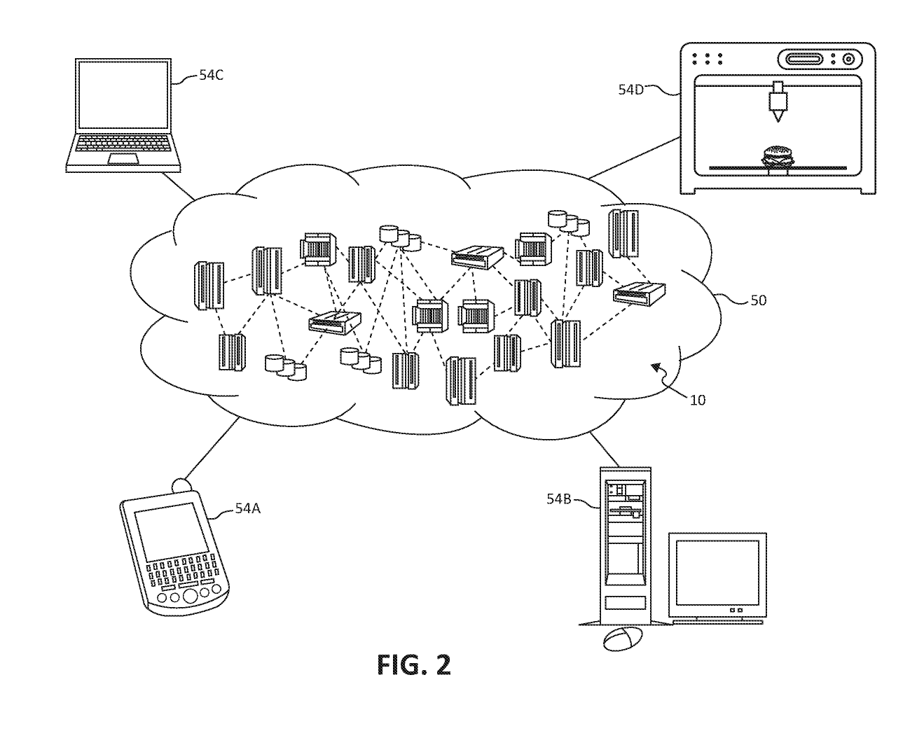

Referring now to FIG. 2, illustrative cloud computing environment 50 is depicted. As shown, cloud computing environment 50 comprises one or more cloud computing nodes 10 with which local computing devices used by cloud consumers, such as, for example, personal digital assistant (PDA), cellular telephone, or tablet 54A, desktop computer 54B, and/or laptop computer 54C, as well as 3D food printer 54D, may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-D shown in FIG. 2 are intended to be illustrative only and that computing nodes 10 and cloud computing environment 50 can communicate with any type of computerized device over any type of network and/or network addressable connection (e.g., using a web browser).

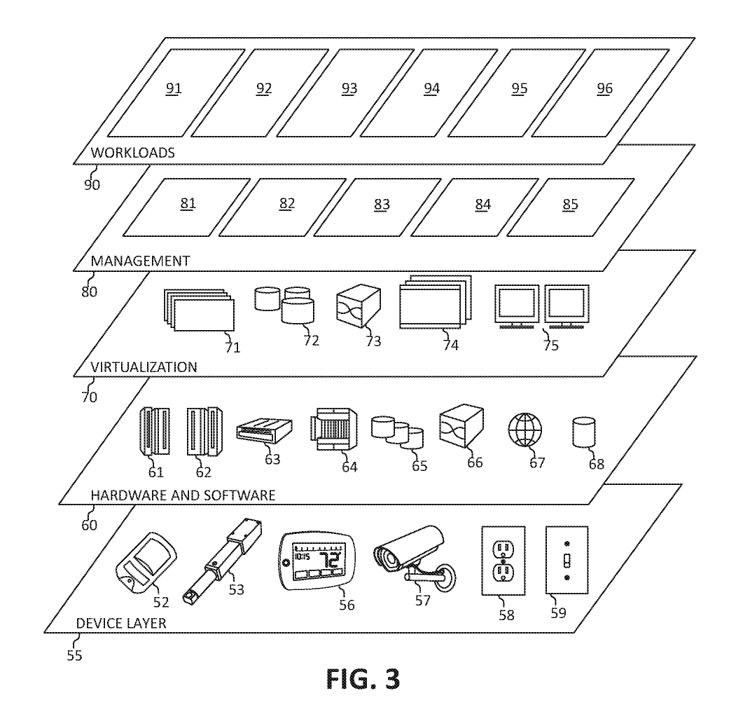

Referring now to FIG. 3, a set of functional abstraction layers provided by cloud computing environment 50 (FIG. 2) is shown. It should be understood in advance that the components, layers, and functions shown in FIG. 3 are intended to be illustrative only and embodiments of the invention are not limited thereto. As depicted, the following layers and corresponding functions are provided:

Device layer 55 includes physical and/or virtual devices, embedded with and/or standalone electronics, sensors, actuators, and other objects to perform various tasks in a cloud computing environment 50. Each of the devices in the device layer 55 incorporates networking capability to other functional abstraction layers such that information obtained from the devices may be provided thereto, and/or information from the other abstraction layers may be provided to the devices. In one embodiment, the various devices inclusive of the device layer 55 may incorporate a network of entities collectively known as the “internet of things” (IoT). Such a network of entities allows for intercommunication, collection, and dissemination of data to accomplish a great variety of purposes, as one of ordinary skill in the art will appreciate.

Device layer 55 as shown includes sensor 52, actuator 53, “learning” thermostat 56 with integrated processing, sensor, and networking electronics, camera 57, controllable household outlet/receptacle 58, and controllable electrical switch 59 as shown. Other possible devices may include, but are not limited to 3D food printers, and various additional sensor devices, networking devices, electronics devices (such as a remote control device), additional actuator devices, so called “smart” appliances such as a refrigerator or washer/dryer, and a wide variety of other possible interconnected objects.

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provides cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provides pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and, in the context of the illustrated embodiments of the present invention, various workloads and functions 96 for 3D printing food items based on information associated with consumers of the food items. One of ordinary skill in the art will appreciate that the image processing workloads and functions 96 may also work in conjunction with other portions of the various abstractions layers, such as those in hardware and software 60, virtualization 70, management 80, and other workloads 90 (such as data analytics processing 94, for example) to accomplish the various purposes of the illustrated embodiments of the present invention.

As previously mentioned, the methods and systems of the illustrated embodiments provide novel approaches for 3D printing food items, or more specifically, for 3D printing food items in such a way to customize 3D printed food items based on information associated with the consumers of the food items. In one example, a request (or command) to print a particular food item is received, and information associated with the consumer of the food item (or consumer information) is retrieved (or received). The food item is 3D printed based on the information associated with the consumer.

For example, if the consumer information indicates that the consumer has celiac disease and/or is allergic to particular ingredients in the existing recipe, the recipe may be modified such that the ingredients in the recipe that include gluten are replaced with gluten-free ingredients and/or the ingredients to which the consumer is allergic are omitted and/or replaced with other ingredients. As another example, the consumer information may indicate that the consumer has set a caloric intake limit for each meal. In such an instance, if appropriate, the existing may be modified to, for example, reduce the portion size of the food item and/or replace some of the ingredients with lower calorie ingredients to reduce the calorie count of the food item.

In some embodiments, the consumer information includes a recipe for the requested food item. That is, the recipe the consumer wishes to use to make the food item may not already be stored in the 3D printing system. Rather, the recipe (i.e., a consumer recipe) may be retrieved by (or downloaded onto) the 3D printing system from, for example, a user (or consumer) profile. After an appropriate recipe has been determined (e.g., changes have been made to an existing recipe based on the consumer information), the consumer may be provided with an indication (e.g., a message) of the changes to the recipe and/or the recipe that will be used before the 3D printing process begins.

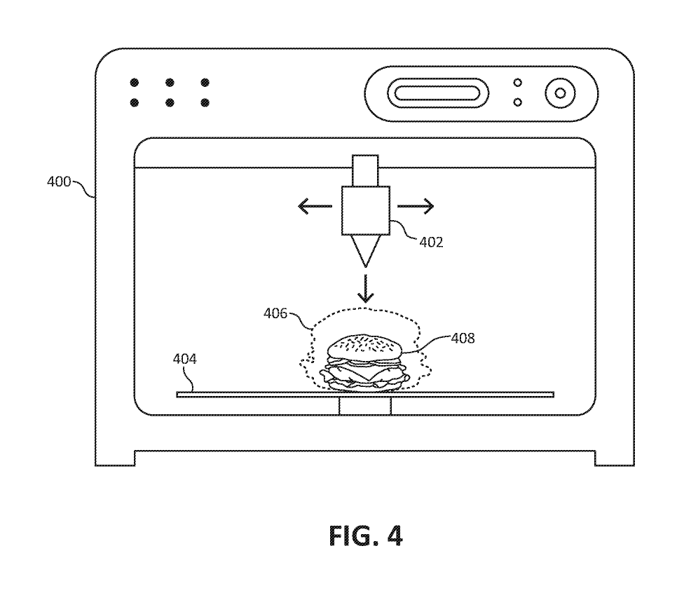

Referring now to FIG. 4, a 3D food printing device (or 3D food printer) 400, according to some embodiments of the present invention, is shown. In the depicted embodiments, the 3D food printer includes a dispenser (or nozzle) 402 positioned above a support 404. The dispenser may be capable of moving (or translating) across the support 404 (e.g., in an X/Y coordinate system) and/or capable of being raised/lowered relative to the support 404. Although not shown in FIG. 4, the 3D food printer 400 may include a computing device (e.g., a control system), such as those described above. It should also be noted that the 3D food printer 400 may be equipped with and/or coupled to stores of various ingredients that may be used by the 3D food printer 400 to create/print various food items. Further, in some embodiments, the 3D food printer 400 is equipped with heating and/or cooling elements to heat and/or cool the ingredients and/or the printed food items.

In some embodiments, the 3D food printer 400 (and/or a control system thereof) receives a request (or command) to 3D print a particular food item. As one example, the requested food item may be a hamburger, as shown in FIG. 4. However, it should be understood that the food item may be of any type capable of being created (or printed) by the 3D food printer (e.g., pizza, desserts, etc.). It should also be understood that embodiments described herein are not limited to food items intended to be consumed by humans. Rather, in some embodiments, the food items may be of the type suitable for consumption by animals (e.g., food for pets and/or wildlife).

The request to print the food item may be received (and/or sent) in any suitable manner, such as, but not limited to, manual selection/input on the 3D food printer 400, through another computing device (e.g., PDA, laptop, desktop, etc. via an electronic message, such as an email, text, an order placed through a website), verbal commands, etc. The requested food item may be selected from a menu associated with the 3D food printer 400 (i.e., a list of food items that the 3D printer is already equipped to create/print). In some embodiments, the request includes information to identify the user (e.g., the consumer of the food item), such as a name, account number, customer number, a profile, etc. The request may also include various preferences, dietary restrictions, etc. associated with the consumer, as described below.

In some embodiments, after (or before or with) the request to 3D print the food item is received, information associated with the consumer (or consumer information) is retrieved (or received) by, for example, the control system of the 3D food printer 400. The consumer information may include various types of data that may be used by the 3D food printer 400 to customize the requested food item. Examples include, but are not limited to, dietary restrictions and/or preferences (e.g., based on health/medical history), preferred ingredient characteristics, and item price limits. As an example of a dietary restriction, the consumer information may indicate that the consumer has placed a calorie limit on their meals. In some embodiments, at least some of the information (or preferences) may be altered and/or provided by nutritional software, such as that stored on a server associated with a weight loss company (e.g., the 3D food printer may communicate with the weight loss company server).

As another example, the consumer information may indicate that the consumer is allergic to particular ingredients or should otherwise avoid some ingredients (e.g., the consumer has celiac disease and should avoid gluten). The consumer may also simply want to use particular ingredients over others (e.g., whole wheat flour instead of plain/white flour). With respect to item price limits, the consumer may want to limit the cost of each meal (e.g., not more than $5). In some embodiments, the consumer information includes a recipe for the requested food item (e.g., a complete list of ingredients and/or instructions for the 3D printer on how to prepare the food item), such as may be the case when the 3D food printer 400 is not already equipped with a recipe for the requested food item.

In some embodiments, the consumer information indicates a preference that only certain aspects of the 3D printed food item be changed. For example, the consumer information may indicate a calorie limit for meals, but specify that the size/weight of the meal should not be changed (e.g., the consumer's preference is to use lower calorie ingredients as opposed to reducing the size and/or weight of the food item). The consumer information may also indicate that some preferences are more important than others. For example, a preference for organic ingredients may have a lower priority than a severe allergy or a condition such as celiac disease. As another example, a preference for a price limit on the food item may be less important than the quality of the ingredients (e.g., use butter instead of margarine, use pecans instead of peanuts, use turbinado sugar instead of fully refined sugar, etc.).

The consumer information may be received (or retrieved) in any suitable manner. For example, the 3D food printer 400 (and/or a control system associated therewith) may scan for and query nearby wireless devices (e.g., PDAs), searching for the consumer information, in the form of, for example, a consumer profile. The consumer profile may also be stored online, such as in (or associated with) a social media profile, which may be accessed by the 3D food printer 400. As another example, the consumer information (or profile) may be stored in (or uploaded to) a server associated with a website (e.g., a consumer account associated with the 3D food printer 400 and/or a company associated with the 3D food printer). The consumer information may also be sent to an appropriate organization (e.g., a company associated with the 3D food printer) via a message, such as over the phone or electronic messages, such as an email or text message.

In some embodiments, the 3D food printer 400 uses the consumer information to modify a recipe for the requested food item, which is already stored on and/or has previously been used by the 3D food printer 400. For example, referring to FIG. 4, a “full portion” or “full size” hamburger 406 is shown (in dashed lines). The full size hamburger 406 may be understood to correspond to a recipe for a hamburger that is already stored on the 3D food printer 400. The 3D food printer 400 may modify the recipe for the hamburger based on the consumer information.

For example, the consumer information may indicate a preference for a calorie limit of 300 calories per meal, while the recipe for the full portion hamburger 406 may create a meal with 500 calories. In such an instance, the 3D food printer 400 (and/or a control system thereof) may modify the existing hamburger recipe to reduce the calorie count of the hamburger to 300 calories. In such an example, the modified recipe may simply be a reduction in the amount of ingredients used, thus resulting in a reduced portion size (e.g., a smaller hamburger). However, it should be noted that the 3D food printer 400 may reduce (or increase) the calorie count of the requested food item in other ways besides simply changing the portion size, such as replacing ingredients with lower calorie options and/or omitting some ingredients altogether. In some embodiments, a price of the food item using (or based on) the modified recipe is determined (or calculated).

After the recipe has been appropriately modified, an indication (or indications) of, for example, the modified recipe is generated and/or provided to the user (e.g., the consumer). The indication may be in the form of an electronic message, such as an email or text message, a visual message (e.g., generated on a display device associated with the 3D food printer 400), or an audio message (e.g., generated by speakers associated with the 3D food printer 400). The indication(s) (or message) may include, for example, a (modified) list of ingredients, a calorie count, and/or a price of the food item using the modified recipe.

In some embodiments, the user (or consumer) is given the option of whether or not to proceed with the 3D printing process using the modified recipe. In such embodiments, the 3D printing process may not proceed until the user provides a response, such as an indication and/or message that the modified recipe is acceptable (e.g., a return electronic message, pressing a button on the 3D food printer 400, etc.). Likewise, in some embodiments, the user may provide a response indicating that the modified recipe is not acceptable and that a different recipe should be used (perhaps with the user specifying the changes he/she desires) or that he/she wishes to cancel the order.

After the recipe has been determined (and perhaps verified by the user), the 3D printing process may proceed. In some embodiments, the printing/creation of the food item includes dispensing the appropriate ingredients from the dispenser 402 in successive layers until the desired food item has been formed, as is commonly understood. Still referring to FIG. 4, with the example of the hamburger described above, the 3D food printer prints/creates a “reduced calorie” hamburger 408, which as shown, is smaller than the full portion hamburger 406. In this way, the 3D printer has modified a previously existing recipe to create a food item that is customized based on the consumer information. After the 3D printing process is complete (and perhaps after payment has been arranged), the user (or consumer) may retrieve the food item (e.g., the hamburger 408) from the 3D food printer 400.

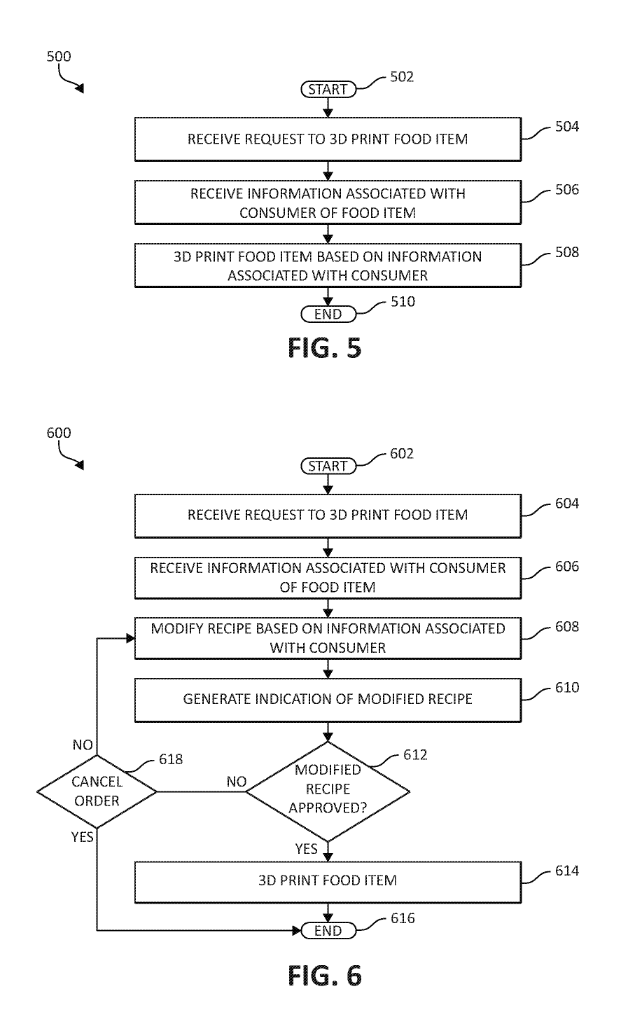

Turning to FIG. 5, a flowchart diagram of an exemplary method 500 for 3D printing a food item is illustrated. Method 500 begins (step 502) with, for example, a user (e.g., a consumer of the food item) selecting a food item and sending a request to have the food item 3D printed. The request to have the food item 3D printed is received (step 504). As described above, the request to have the food item 3D printed may be sent/received in any suitable manner, such as manual selection/input on the 3D food printer, through another computing device (e.g., PDA, laptop, desktop, etc. via an electronic message, such as an email, text, an order placed through a website), verbal commands, etc.

Information associated with the consumer of the food item is (then) received (or retrieved) (step 506). The information may include various types of data that may be used by the 3D food printer to customize the requested food item. Examples include, but are not limited to, dietary restrictions/preferences, preferred ingredient characteristics, and item price limits. As described above, the information may be received (or retrieved) in any suitable manner, such as a query sent to nearby wireless devices (e.g., PDAs), pulled from a social media profile, found in a database stored on a server associated with a website, etc.

The requested food item is then 3D printed based on the information associated with the consumer of the food item (step 508). As described above, the 3D printing of the food item may include, for example, modifying a recipe for the food item stored in a computing system associated with the 3D food printer based on the information associated with the consumer. In some embodiments, the recipe for the food item is included in the information associated with the consumer and is used to 3D print the food item. Before the 3D printing process begins, an indication of the recipe to be used (e.g., the modified recipe) may be sent to the user (or consumer) so that it may be approved.

Method 500 ends (step 510) with, for example, the 3D printing process completing the food item and the food item being retrieved from the 3D food printer. It should be understood that in some embodiments the steps described above may be performed in a different order. For example, the 3D food printer (and/or a control system thereof) may retrieve the information associated with the consumer before the request to 3D print a food item is received (e.g., an appropriate wireless device, such as a PDA, may be detected and queried before the request is sent).

Turning to FIG. 6, a flowchart diagram of an exemplary method 600 for 3D printing a food item, including additional features of the embodiments described herein, is illustrated. Method 600 begins (step 602) with, for example, a user (e.g., a consumer of the food item) selecting a food item and sending a request to have the food item 3D printed. The request to have the food item 3D printed is received (step 604). As described above, the request to have the food item 3D printed may be sent/received in any suitable manner, such as manual selection/input on the 3D food printer, through another computing device (e.g., PDA, laptop, desktop, etc. via an electronic message, such as an email, text, an order placed through a website), verbal commands, etc.

Information associated with the consumer of the food item is (then) received (or retrieved) (step 606). The information may include various types of data that may be used by the 3D food printer to customize the requested food item. Examples include, but are not limited to, dietary restrictions/preferences, preferred ingredient characteristics, and item price limits. As described above, the information may be received (or retrieved) in any suitable manner, such as a query sent to nearby wireless devices (e.g., PDAs), pulled from a social media profile, found in a database stored on a server associated with a website, etc.

The information associated with the consumer is then used to modify (or create) a recipe for the food item (step 608). In some embodiments, a recipe already stored in (and/or previously used by) the 3D food printer is modified based on the information, as described above. However, in some embodiments, the recipe for the food item is included in the information associated with the consumer and is used to 3D print the food item.

In the depicted embodiment, an indication of the recipe to be used (e.g., the modified recipe) may be sent to the user (or consumer), such as in the form of an electronic message or visual message (step 610). If the recipe is approved (e.g., via an appropriate input) by the consumer (or another user) (step 612), the food item is 3D printed using the (modified) recipe (step 614), as described above, and method 600 ends (step 616) with, for example, the food item being retrieved from the 3D food printer.

If the recipe is not approved by the consumer (step 612), a query is provided to the consumer as to whether or not he/she wishes to cancel the order/request for the 3D printed food item (step 618). If the consumer indicates that he/she wishes to cancel the order (step 618), method ends (step 616) with, for example, no food item being 3D printed.

However, if the consumer indicates he/she does not wish to cancel the order (step 618), in the depicted embodiment, the recipe is (again) modified (step 608). For example, the recipe may be again changed, this time using a different list of ingredients, while still conforming to the consumer's preferences. Method 600 then (again) proceeds as described above.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowcharts and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowcharts and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowcharts and/or block diagram block or blocks.

The flowcharts and block diagrams in the Figures illustrate the architecture, functionality, and operation of possible implementations of systems, methods, and computer program products according to various embodiments of the present invention. In this regard, each block in the flowcharts or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts or carry out combinations of special purpose hardware and computer instructions.

1. A method, by a processor, for 3D printing a food item, comprising:
receiving a request to 3D print a food item;
receiving information associated with a consumer of the food item; and
3D printing the requested food item based on the information associated with the consumer of the food item, wherein the 3D printing of the requested food item includes modifying a recipe for the requested food item based on the information associated with the consumer of the food item.

2. The method of claim 1, wherein the information associated with the consumer of the food item includes at least one dietary restriction of the consumer of the food item.

3. The method of claim 2, wherein the modifying of the recipe for the requested food item comprises at least one of adjusting a portion size of the recipe or changing an ingredient list for the recipe based on the at least one dietary restriction of the consumer of the food item.

4. The method of claim 3, wherein the at least one dietary restriction includes a calorie limit for the consumer or a list of allergens for the consumer.

5. The method of claim 1, further including generating an indication of said modified recipe for the requested food item before the 3D printing of the requested food item.

6. The method of claim 1, further including determining a price of the requested food item based on said modified recipe.

7. The method of claim 6, further including generating an indication of the price of the requested food item based on said modified recipe.

8. A system for 3D printing a food item, comprising:
a processor that
receives a request to 3D print a food item;
receives information associated with a consumer of the food item; and
causes the requested food item to be 3D printed based on the information associated with the consumer of the food item, wherein the 3D printing of the requested food item includes modifying a recipe for the requested food item based on the information associated with the consumer of the food item.

9. The system of claim 8, wherein the information associated with the consumer of the food item includes at least one dietary restriction of the consumer of the food item.

10. The system of claim 9, wherein the modifying of the recipe for the requested food item comprises at least one of adjusting a portion size of the recipe or changing an ingredient list for the recipe based on the at least one dietary restriction of the consumer of the food item.

11. The system of claim 10, wherein the at least one dietary restriction includes a calorie limit for the consumer or a list of allergens for the consumer.

12. The system of claim 8, wherein the processor causes an indication of said modified recipe for the requested food item to be generated before the 3D printing of the requested food item.

13. The system of claim 8, wherein the processor determines a price of the requested food item based on said modified recipe.

14. The system of claim 13, wherein the processor causes an indication of the price of the requested food item based on said modified recipe to be generated.

15. A computer program product for 3D printing a food item by a processor, the computer program product comprising a non-transitory computer-readable storage medium having computer-readable program code portions stored therein, the computer-readable program code portions comprising:
an executable portion that receives a request to 3D print a food item;
an executable portion that receives information associated with a consumer of the food item; and
an executable portion that causes the requested food item to be 3D printed based on the information associated with the consumer of the food item, wherein the 3D printing of the requested food item includes modifying a recipe for the requested food item based on the information associated with the consumer of the food item.

16. The computer program product of claim 15, wherein the information associated with the consumer of the food item includes at least one dietary restriction of the consumer of the food item.

17. The computer program product of claim 16, wherein the modifying of the recipe for the requested food item comprises at least one of adjusting a portion size of the recipe or changing an ingredient list for the recipe based on the at least one dietary restriction of the consumer of the food item.

18. The computer program product of claim 17, wherein the at least one dietary restriction includes a calorie limit for the consumer or a list of allergens for the consumer.

19. The computer program product of claim 15, wherein the computer-readable program code portions further include an executable portion that causes an indication of said modified recipe for the requested food item to be generated before the 3D printing of the requested food item.

20. The computer program product of claim 15, wherein the computer-readable program code portions further include an executable portion that determines a price of the requested food item based on said modified recipe.

21. The computer program product of claim 20, wherein the computer-readable program code portions further include an executable portion that causes an indication of the price of the requested food item based on said modified recipe to be generated.
